(19) United States
(12) Patent Application Publication
(10) Pub. No.: US 2004/0218558 A1
(43) Pub. Date: Nov. 4, 2004

(54) Dynamic IP address allocation

(75) Inventor: Fredrik Johansson, Nacka (SE)

Correspondence Address: BANNER & WITCOFF, 1001 G STREET N W, SUITE 1100, WASHINGTON, DC, 20001, US

(73) Assignee: Interactive People Unplugged AB, Stockholm (SE)

(21) Appl. No.: 10/786,236

(22) Filed: Feb. 26, 2004

Related U.S. Application Data
(60) Provisional application No. 60/449,844, filed on Feb. 27, 2003.

(51) Int. Cl. H04J 3/16; H04Q 7/00; H04L 12/56

(52) U.S. Cl. 370/313; 370/349; 370/401

(57) ABSTRACT

The present invention relates to method for a Mobile Node (3) to acquire a Home Address that will be maintained while roaming between a home network (4) and a foreign network (7), where the home address is acquired dynamically from a centralized server (2) maintaining a pool of addresses, and where a Home Agent (1) allocates the address on behalf of the Mobile Node (3) from the centralized server (2), using a unique identifier provided by the Mobile Node (3).

### FIELD OF INVENTION

The present invention relates to mobile data communication in general. More specifically, the present invention describes a technique to dynamically allocate an IP address to a Mobile IP client without adding any new extensions to the Mobile IP protocol. It also describes how the lease of such an address can be maintained by different entities in the network depending on the current attachment of the Mobile Node to the network.

### DESCRIPTION OF THE BACKGROUND ART

The following definitions are introduced for the purpose of clarity.

DHCP Dynamic Host Configuration Protocol. DHCP is an Internet Engineering Task Force (IETF) standard for allocating Internet Protocol addresses and other configuration information to User Systems. User Systems can either be Fixed Hosts or Mobile Hosts. The allocation is done each time when the User System is started. A DHCP server allocates the information, which is then transferred to a DHCP client. An Internet Service Provider or an IT-department controls the DHCP server. The DHCP client is a SW functionality embedded in the User System.

FA Foreign Agent: The primary responsibility of an FA is to act as a tunnel agent which establishes a tunnel to a HA on behalf of a Mobile Node in mobile IP.

HA Home Agent: The primary responsibility of the HA is to act as a tunnel agent which terminates the mobile IP tunnel, and which encapsulates datagrams to be sent to the Mobile Node in mobile IP.

IETF Internet Engineering Task Force: The IETF is the standardization organization for the Internet community.

IP Internet Protocol. IP is a network layer protocol according to the ISO protocol layering. IP is the major end-to-end protocol between Mobile and Fixed End-Systems for Data Communications.

MIP Mobile IP: MIP is an IP mobility standard being defined by the IETF with the purpose to make IP networks mobility aware, i.e. providing IP entities knowledge on where a Mobile Node is attached to the network. The standard includes the definition of a Foreign Agent and a Home Agent.

MN Mobile Node: The MN comprises both the Terminal Equipment (TE) and the Mobile Termination (MT).

NAI Network Access Identifier: An identifier that uniquely identifies the Mobile Node. It consists of two parts, a user name and a realm part separated by a @-sign, e.g. john.doe@bigoperator.inc

RFC Request For Comment: The collective name of standard documents produced within the IETF. Each standard document starts with RFC and a number, e.g. RFC2794 is the standard for Network Access Identifier for Mobile IPv4.

Mobile IP is defining a Home Agent as the anchor point with which the Mobile Node always has a relationship, and a Foreign Agent, which acts as the local tunnel-endpoint at the access network where the Mobile Node is visiting. While moving from one IP sub network to another, the Mobile Node point of attachment (FA) may change. At each point of attachment, mobile IP either requires the availability of a standalone Foreign Agent, the usage of a co-located care-of address in the Mobile Node itself in the case that no Foreign Agent is available, or the de-registration from Mobile IP if in the home network.

In general the Mobile IP protocol uses the Mobile Node's home address as unique identifier for authentication and separation of tunnels. However, as identifier the IP address is not that user friendly, instead a new format called Network Access Identifier, NAI (RFC 2794), was introduces as mean to uniquely identify the Mobile Node. The NAI is more understandable for the human and therefore easier to associate with a user. When introducing the NAI dynamic allocation of the home address was also made possible. This reduces the number of addresses needed by the service provider from one per user to the number of simultaneously connected users. Current solutions for address allocation from a centralized pool of addresses require the client to maintain the address lease during the time it is used. This works well for non-mobile nodes since they will always stay in the same place and is always able to contact the centralized server. In a mobile environment, it might be necessary to allow for multiple entities to maintain the lease at different periods of time.

The present invention aims at providing a method to allocate a home address via a centralized server maintaining the address pool, while not requiring any changes to the Mobile IP protocol. It also describes the different methods for maintaining the lease when the Mobile Node is located in its home network and when it's in a visited network.

The following references are also of general interest for the understanding of the present invention:

Alexander, S. et al; DHCP Options and BOOTP Vendor Extensions; http://www.ietf.org/rfc/rfc2132.txt; March 1997

Calhoun, Pat et al; Mobile IP Network Access Identifier Extension for IPv4; RFC2794; http://www.ietf.org/rfc/rfc2794.txt; March 2000

Droms, R.; Dynamic Host Configuration Protocol; RFC2131; http://www.ietf.org/rfc/rfc2131.txt; March 1997

Perkins, Charlie; IP Mobility Support; RFC3344; http://www.ietf.org/rfc/rfc3344.txt; August 2002.

### SUMMARY OF THE PRESENT INVENTION

The present invention relates to two situations, a first situation where a Mobile Node start with registering in a visited network, and a second situation where a Mobile Node starts when located on its home network.

The first situation described is when a Mobile Node registers in a visited network. The Mobile Node will send a registration request to its Home Agent where it requests to receive a dynamically allocated address, to identify itself it uses a unique identifier, e.g. the NAI. The home agent will use this unique identifier when sending an address allocation request to a centralized server, how this server is discovered is outside the scope of the invention. It is obvious for the skilled person how to configure any server, such as a DHCP server, with standard software for DHCP. The Home Agent stores the information received from the server in a table in order to be able to maintain the lease. The allocated address is returned to the Mobile Node in the registration reply. The Mobile Node will use the address received in the registration reply as its home address, As long as the Mobile Node updates its registration the home agent will continue to maintain the lease towards the server handling the address pool.

If a Mobile Node moves from a visited network to its home network it will de-register from the Home Agent. Upon receiving a de-registration request the Home Agent will remove the entry for that address from its table and stop maintaining the lease towards the server. But in order for the Mobile Node to be able to continue using its home address without it expiring from the server, the Mobile Node must take over the maintenance of the leased address. This is done by the client sending a request to renew the lease using the same unique identifier to the DHCP server, e.g. in the case of DHCP the NAI will be put in the client-identifier option.

The second situation is a Mobile Node that starts when located on its home network. The Mobile Node will then hear the advertisements from its home agent and will not send a registration request to the Home Agent. Instead it has to acquire its home address by some other mean. To do this the Mobile Node will send an address allocation request to the centralized server using a unique identifier. The server will allocate an address and send it back to the Mobile Node. In the case of DHCP, the Mobile Node will send a DHCP discover message to determine where the server is, in response it will get a suggestion on an address, which it then can request to allocate, by sending a DHCP request.

If a Mobile Node moves from its home network to a visited network it can no longer maintain the lease with the centralized server. To inform the Home Agent to take over the maintenance it will request dynamic allocation of home address in its registration request. Included in this registration request the Mobile Node will send the same unique identifier as used when allocating the address in its home network. The home agent will request an address from the centralized server in the same way as mentioned above. Since the same identifier is used, the server will allocate the same address as the Mobile Node had allocated when located in its home network. The Home Agent will now maintain the lease as long as the Mobile Node updates its registration.

### BRIEF DESCRIPTION OF DRAWINGS

The foregoing and other objects, features, and advantages of the invention will be apparent from the following description of preferred example embodiments as well as illustrated in the accompanying drawings in which reference characters refer to the same parts throughout, where:

FIG. 1 is a flow chart diagram showing a Mobile node starting or returning to its home network, and

FIG. 2 is a flow chart diagram showing a Mobile Node starting or moving to a visited network.

### DETAILED DESCRIPTION OF EMBODIMENTS AS PRESENTLY PREFERRED

In the following description, for the purposes of explanation and not limitation, specific details are set forth, such as particular embodiments, circuits, signal formats, techniques, etc. in order to provide a thorough understanding of the present invention. Although specific protocols are referred to for the purpose of facilitation the description, the present invention is not necessarily limited to such specific protocols. However, it will be apparent to one skilled in the art that the present invention may be practiced in other embodiments that depart from these specific details. In other instances, detail description of well-known methods, devices, and circuits are omitted so as not to obscure the description of the present invention under unnecessary detail.

The present invention provides a dynamic address allocation technique requiring no awareness by the Mobile IP protocol but merely adds some extra intelligence in some nodes.

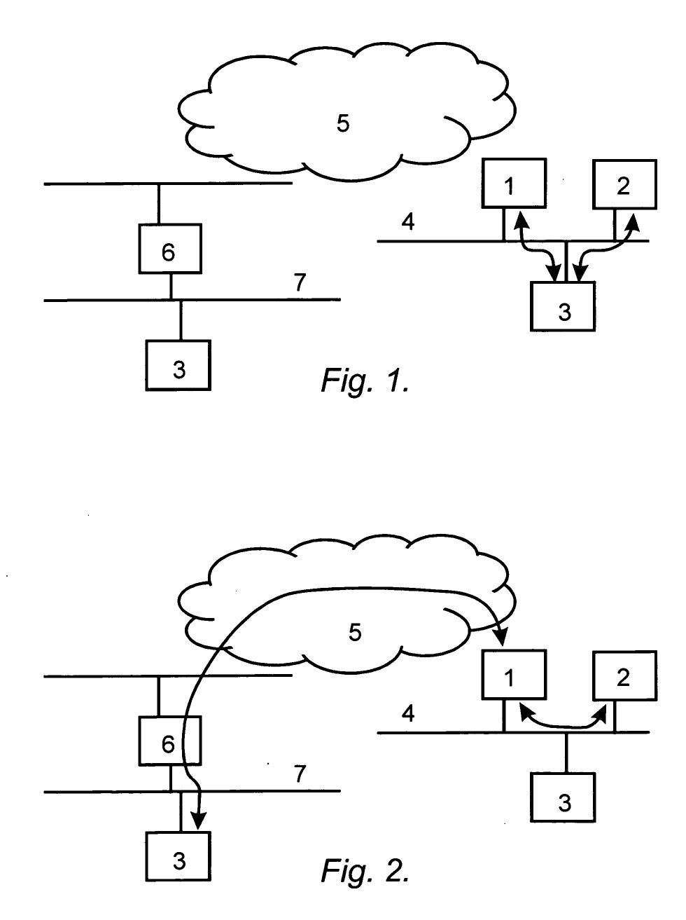

FIG. 1 illustrates a Mobile Node 3 starting at its home network 4 or returning to its home network. The Mobile Node will hear agent advertisements from its Home Agent 1 on which it can determine that it's located in its home network. This will cause the Mobile Node to send a registration request to the Home Agent with the lifetime set to zero, causing a deregistration. The Mobile Node will also send a request to the DHCP 2 server to request allocation of an IP address or to renew and take over the lease of an existing address, it uses its NAI as unique identifier in the client-identifier option. The DHCP server will either allocate a new address if none is previously allocated or return the address already allocated to the Mobile Node. When the Home Agent receives a deregistration it must stop maintaining the leases it have for that Mobile Node, however, it must not send a DHCP release to the DHCP server since this will cause the server to release the address, thus it might not be available for the Mobile Node to take over.

FIG. 2 illustrates a Mobile Node 3 registering in a foreign network 7, it may be using a Foreign Agent 6 or in co-located mode. The Mobile Node 3 will send a registration request to the Home Agent 1 asking for dynamic allocation of the home address via the Foreign Agent 6 and the Internet 5. This is done even if the Mobile Node acquired an address while located in its home network 4 since the Home Agent must know that it should take over the maintenance of the lease. Upon receiving the registration request, the Home Agent will send out a DHCP request in order to allocate an IP address or to take over a previously leased address. The DHCP server will, in the same way as above, allocate a new or return a previously allocated address based on the value provided in the client-identifier option, which will be the client NAI taken from the registration request.

It will be understood that the invention is not restricted to the aforedescribed and illustrated exemplifying embodiment thereof and that modifications can be made within the scope of the inventive concept as illustrated in the accompanying claims.

1. A method for a Mobile Node to acquire a home address where the Mobile Node is located in a foreign network, characterized in that said home address is acquired dynamically from a centralized server maintaining a pool of addresses.

2. A method according to claim 1, characterized in that a Home Agent allocates said address on behalf of the Mobile Node from the centralized server, using a unique identifier provided by the Mobile Node.

3. A method according to claim 2, characterized in that the Home Agent maintains the allocated address on behalf of the Mobile Node.

4. A method according to claim 3, characterized in that the Home Agent stops maintaining the lease when the Mobile Node de-register or when the Mobile Node's registration times out.

5. A method according to claim 1, characterized in that the centralized server uses the DHCP protocol.

6. A method according to claim 5, characterized in that the Home Agent allocate the address on behalf of the Mobile Node from the centralized DHCP server using the NAI provided by the Mobile Node as unique identifier in the client-identifier option.

7. A method according to claim 6, characterized in that the Home Agent maintains the allocated address on behalf of the Mobile Node by renewing the lease when it is about to expire.

8. A method for a Mobile Node to acquire a home address where the Mobile Node is located in its home network, characterized in that said Mobile Node acquires the home address directly from a centralized pool of addresses using a unique identifier that it later can provide to a Home Agent.

9. A method according to claim 8, characterized in that the Mobile Node maintains and renews the lease while located in its home network.

10. A method according to claim 9, characterized in that the Mobile Node stops maintaining the lease when the Mobile Node moves to a visited network and registers with its home agent.

11. A method according to claim 10, characterized in that the Home Agent takes over the maintenance of the lease when the mobile registers with it when moving out from its home network.

12. A method according to claim 8, characterized in that the centralized server uses the DHCP protocol.

13. A method according to claim 12, characterised in that the Mobile Node acquires the address directly from a centralized DHCP server using its NAI as unique identifier in the client-identifier option.

14. A method according to claim 11, characterized in that the Home Agent takes over the maintenance of the lease by sending a DHCP request with the Mobile Node's NAI in the client-identifier option to the DHCP server when the mobile registers with it when moving out from its home network.

15. A method for a Mobile Node to acquire a Home Address while visiting a foreign network, characterized in that the Mobile Node send a registration request to its Home Agent, where it requests to receive a dynamically allocated address, that the Mobile Node identifies itself through a unique identifier, e.g. the NAI, that the home agent uses this unique identifier when sending an address allocation request to a centralized server located in the home network of the Mobile Node, that the Home Agent stores the information received from the server in a table in order to be able to maintain the lease, and that the allocated address is returned to the Mobile Node in the registration reply.

16. A method according to claim 15, characterized in that the Mobile Node uses the address received in the registration reply as its home address, and that the home agent continues to maintain the lease towards the server handling the address pool as long as the Mobile Node updates its registration.

17. A method according to claim 15, characterized in that, when the Mobile Node moves from the visited network to its home network, it will de-register from the Home Agent, that, upon receiving a de-registration request, the Home Agent removes the entry for that address from its table and stops maintaining the lease towards the server, and that the Mobile Node takes over the maintenance of the leased address.

18. A method according to claim 17, characterized in that the Mobile Node takes over the maintenance of the lease by the client sending a request to renew the lease using the same unique identifier to the DHCP server, e.g. in the case of DHCP the NAI will be put in the client-identifier option.

19. A method for a Mobile Node to acquire a home address where the Mobile Node that starts when located on its home network, characterized in that the Mobile Node hears the advertisements from its home agent without sending a registration request to the Home Agent, that Mobile Node acquire its home address by sending an address allocation request to the centralized server of its home network using a unique identifier, and that the server allocates an address and send it back to the Mobile Node.

20. A method according to claim 19, characterized in that, if said server is a DHCP server, the Mobile Node sends a DHCP discover message to determine where the server is, that, in response, it gets a suggestion on an address, and that the Mobile Node request to allocate the suggested address by sending a DHCP request.

21. A method according to claim 19, characterized in that, when the Mobile Node moves from its home network to a visited network where it can no longer maintain the lease with the centralized server, the Mobile Node will request dynamic allocation of home address in its registration request to inform the Home Agent to take over the maintenance, that, included in this registration request, the Mobile Node sends the same unique identifier as used when allocating the address in its home network, that the home agent will requests an address from the centralized server using the same identifier, that the server allocates the same address as the Mobile Node had allocated when located in its home network, and is that the Home Agent thereafter maintains the lease as long as the Mobile Node updates its registration.
